(19) United States
(12) Patent Application Publication
(10) Pub. No.: US 2026/0238544 A1
(43) Pub. Date: Aug. 13, 2026

(54) DATA MODEL CONVERSION FOR A RADIO ACCESS NETWORK (RAN) INTELLIGENT CONTROLLER

(71) Applicant: Juniper Networks, Inc., Sunnyvale, CA (US)

(72) Inventors: Arda Akman, San Ramon, CA (US); Burcu Sahin, San Jose, CA (US); Ozgur Bulut, Istanbul (TR); Anastasios Melissopoulos, Athens (GR)

(21) Appl. No.: 19/093,134

(22) Filed: Mar. 27, 2025

(30) Foreign Application Priority Data
Feb. 10, 2025 (GR) 20250100113

(51) Int. Cl. H04L 41/0806; H04L 41/0681

(52) U.S. Cl. CPC H04L 41/0809; H04L 41/0681

(57) ABSTRACT

Techniques are disclosed for converting between data models within a Radio Access Network (RAN) Intelligent Controller (RIC) for a mobile network. For example, a model conversion application receives, from a RIC, a first request specifying first attributes according to a first data model. The model conversion application generates, based on the first attributes, a second request specifying unique identifiers and first objects according to a second data model. The model conversion application sends the second request to the RIC for sending to a RAN for the mobile network over a management interface. In some examples, the first request comprises a Service Management and Exposure (SME) request according to the first data model and the second request comprises at least one of a Configuration Management (CM) read request, a Performance Management (PM) read request, or a Fault Management (FM) read request according to the second data model.

This application claims the benefit of Greece Application No. 20250100113, which was filed on Feb. 10, 2025, the entire content of which is incorporated herein by reference.

### TECHNICAL FIELD

The disclosure generally relates to mobile network management.

### BACKGROUND

Computer networks have become ubiquitous, and the number of network applications, network-connected devices, and types of network-connected devices are rapidly expanding. Such devices now include computers, smartphones, Internet-of-Things (IoT) devices, vehicles, medical devices factory equipment, etc. 5G mobile network architectures enhanced the ability to provide communication services using cloud-based network function virtualization (NFV). Specialized networks can be created using the Radio Access Network (RAN) of a mobile network operator combined with functions of a 5G core. For example, networks can be created for a specific service level agreement (SLA), special use cases, or other specific requirements. Examples of such networks include private mobile networks, industrial networks, a dedicated network for connected vehicles, etc.

### SUMMARY

In general, the disclosure describes techniques for converting between data models using applications of a Radio Access Network (RAN) Intelligent Controller (RIC) for a mobile network. In some examples, a RIC may implement a standardized or standards-specified data model, such as an Open RAN (O-RAN) data model to provide Operations, Administration, and Maintenance (OAM) operations for a RAN. However, the RAN may use network devices provided by various vendors, some of which may use a vendor-specific data model for implementing OAM telemetry and control. As a result, such vendors'network devices may belong to the RAN but not support standard O-RAN data models. Supporting the various vendor-specific data models conventionally may require complex configuration in the OAM chain, thereby increasing the cost and maintenance for network operations.

Using the techniques described herein, a model conversion application for a RIC for a mobile network may provide capabilities for converting between the various different data models implemented across the mobile network. For example, the model conversion application receives, from the RIC via an R1 interface, a first request specifying one or more first attributes according to a first data model. In some examples, the first request comprises a Service Management and Exposure (SME) request for OAM data for the RAN formulated in accordance with a standardized data model. The model conversion application generates, based at least in part on the one or more first attributes, a second request specifying one or more unique identifiers for nodes of the RAN and one or more first objects according to a second data model. In some examples, the unique identifiers are distinguished names (DNs) that identify nodes and/or equipment of the RAN. In some examples, the second request comprises a Configuration Management (CM) read request, a Performance Management (PM) read request, or a Fault Management (FM) read request formulated in accordance with a vendor-specific data model. The model conversion application sends, to the RIC, the second request for sending, by the RIC, over a management interface (such as an OAM, O1, or O2 interface) to the RAN for the mobile network.

The model conversion application receives, from the RIC, a second response received by the RIC over the management interface. The second response is responsive to the second request and specifies one or more second objects according to the second data model. In some examples, the second response comprises a CM read response responsive to the CM read request and formulated in accordance with the vendor-specific data model. In some examples, the second response comprises a PM read response responsive to the PM read request and formulated in accordance with the vendor-specific data model. In some examples, the second response comprises an FM read response responsive to the FM read request and formulated in accordance with the vendor-specific data model. The model conversion application generates, based at least in part on the one or more second objects, a first response, the first response specifying one or more second attributes according to the first data model and responsive to the first request. For example, the first response comprises an SME response responsive to the SME request formulated in accordance with the standardized data model. The model conversion application provides the first response to the RIC to support OAM operations by the RIC.

The techniques of the disclosure may provide specific improvements to the computer-related field of mobile telecommunications and networking that may have one or more practical applications. For example, the techniques of the disclosure may enable a RIC for a mobile network to use a standardized or standards-specified data model, such as an O-RAN data model, for OAM operations while maintaining compatibility with various other types of data models that implement OAM telemetry and control, such as vendor-specific data models. Moreover, the techniques of the disclosure may enable an rApp or xApp implemented by a non-real-time (non-RT) RIC or near-real-time (near-RT) RIC to provide such compatibility, thereby reducing the complexity, cost, and maintenance of supporting different OAM data models across a mobile network. For example, a vendor of an rApp or xApp that implements the model conversion and may upgrade the rApp/xApp to support new devices and new non-O-RAN standard data models without requiring an upgrade to other RIC components/applications. In addition, the techniques of the disclosure may enable a network operator to upgrade the model conversion application described herein to support additional data models, obviating the need to update each of the RIC and other rApps/xApps to support every new data model, and thereby simplifying the process of updating and upgrading the RIC. Furthermore, the model conversion application described herein may remove the need for additional layers of abstraction between the RIC and EMS services, thereby reducing the complexity of implementing O-RAN within a mobile network.

In one example, this disclosure describes a computing system comprising processing circuitry having access to a memory, the processing circuitry configured to: execute a model conversion application for a Radio Access Network (RAN) Intelligent Controller (RIC) for a mobile network, the model conversion application configured to: receive, from the RIC, a first request specifying one or more first attributes according to a first data model; generate, based at least in part on the one or more first attributes, a second request specifying one or more unique identifiers for nodes of the RAN and one or more first objects according to a second data model; and send, to the RIC, the second request for sending, by the RIC, over a management interface to a RAN for the mobile network.

In another example, this disclosure describes a method comprising: receiving, by a model conversion application for a Radio Access Network (RAN) Intelligent Controller (RIC) for a mobile network, from the RIC, a first request specifying one or more first attributes according to a first data model, the model conversion application executed by processing circuitry; generating, by the model conversion application and based at least in part on the one or more first attributes, a second request specifying one or more unique identifiers for nodes of the RAN and one or more first objects according to a second data model; and sending, by the model conversion application and to the RIC, the second request for sending, by the RIC, over a management interface to a RAN for the mobile network.

In another example, this disclosure describes non-transitory, computer-readable media comprising instructions that, when executed, are configured to cause processing circuitry to: execute a model conversion application for a Radio Access Network (RAN) Intelligent Controller (RIC) for a mobile network, the model conversion application configured to: receive, from the RIC, a first request specifying one or more first attributes according to a first data model; generate, based at least in part on the one or more first attributes, a second request specifying one or more unique identifiers for nodes of the RAN and one or more first objects according to a second data model; and send, to the RIC, the second request for sending, by the RIC, over a management interface to a RAN for the mobile network.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1A is a block diagram illustrating an example network system configured to provide compatibility for different data models in a mobile network, in accordance with one or more techniques of the disclosure.

FIG. 1B is a block diagram illustrating further example details of the Non-RT RIC of the Service Management and Orchestration of FIG. 1A.

FIG. 1C is a block diagram illustrating further example details of the Near-RT RIC of FIG. 1A.

FIG. 2 is a block diagram illustrating an example computing system in detail, in accordance with the techniques of this disclosure.

FIG. 3 is a flowchart illustrating an example operation in accordance with the techniques of this disclosure.

FIGS. 4A-4C are flowcharts illustrating example operations in accordance with the techniques of this disclosure.

Like reference characters refer to like elements throughout the figures and description.

### DETAILED DESCRIPTION

O-RAN is a new technology with many benefits, but requires O-RAN-compliant interface support from RAN (base station) vendors. For the Non-RT RIC case, this interface is the O1 interface, which handles OAM (Operations, Management and Administration) operations such as configuration management (CM), performance management (PM), fault management (FM), etc.

Mobile network operators have existing deployments that include non-O-RAN-based systems (base stations) that should be supported by O-RAN, especially by the Non-RT RIC through a management interface (such as an OAM, O1, or O2 interface). O-RAN defines an open O1 interface for OAM purposes, but there are few (if any) RAN vendors that provide O1 support. Instead, RAN vendors implement their own interfaces with their own data models that are not standards-compliant. These RAN vendors, both traditional and new, are also either very slow or (due to business-level decisions) not willing to upgrade their vendor-specific OAM interfaces and data models to implement O-RAN-based interfaces, such as the O1 interface, and standards-based data models, such as those set forth by O-RAN.

Operators would like to modernize their network to O-RAN based systems, but they already have deployments of traditional RAN vendors that do not have O-RAN support. An operator may naturally request support from traditional RAN vendors as part of an O-RAN solution so that the operator can utilize their existing investment, while investing to O-RAN-based RAN vendors going forward. However, because the existing RAN (base station) deployments in operator networks do not support O-RAN interfaces, operators need a way of enabling O-RAN benefits for those existing systems. Therefore, there is a substantial need to enable non-O-RAN-based RAN nodes (whether traditional or newer vendors) to be controlled by the non-RT RIC and near-RT RIC.

To support these vendor-specific interfaces and data models, there are two existing solutions conventionally. First, a network operator may implement a vendor-specific OAM solution, such as a vendor-specific interface in the Non-RT RIC, so that the Non-RT RIC can interface with that particular vendor. However, these solutions handle only one vendor and require a layer to sit between the RAN vendor nodes or their EMS and the non-RT RIC or near-RT RIC. Second, a network operator may add a multi-vendor Element Management System (EMS) product/layer between the Non-RT RIC and the RAN nodes (or their EMS layer). This solution also has the drawback of requiring an additional layer between the RAN vendor nodes/ EMS and the RIC, and additionally may have limited vendor support. Furthermore, both of these solutions introduce added complexity in the OAM chain, hence increased cost and maintenance challenges for the operator to maintain the additional layers. This is actually the reverse of the O-RAN promise of simplified, unified, and lower cost network operations, which discourages adoption and implementation of the O-RAN standard. In addition, there is a RAN vendor software version issue with conventional solutions. The OAM information changes from vendor to vendor, and at times, the RIC is required to support more than one version of the RAN vendor software/OAM. This brings the challenge of upgrading the multi-vendor EMS systems, as well as introduces potential compatibility issues with the Non-RT RIC amongst the network devices of the various vendors within the mobile network. Operators desire a solution that reduces complexity and cost and simplifies network management by reducing these additional layers.

Other challenges to conventional solutions exist. There are conventional Central Self Organizing Network (C-SON) solutions that an administrator may desire to upgrade to O-RAN compliance. These conventional C-SON platforms parse specific RAN OAM information to provide “logical” RAN information so as to simplify application development. Some examples of C-SON solutions include Direct Access to Cell ID, neighborhood info, etc. These conventional solutions are in contrast to the 3GPP/O-RAN network resource model, which provides a standardized data model of hierarchical object models, with attributes within each object, and does not require the need for parsing the attributes of multiple objects to get the same “logical” RAN info. There is now a challenge for third party developers (whether vendors or network operators themselves) to heavily modify their C-SON implementation to switch from providing direct access to “logical” RAN info to implementing a 3GPP/O-RAN-based network resource model.

In accordance with the techniques of the disclosure, a RIC (or SMO) implements a model conversion application that can convert vendor-specific OAM data models to other OAM data models, such as standards-based (such as a 3GPP/O-RAN data model) or other vendor-specific OAM data models. The model conversion application described here may support a single RAN vendor, or may support multiple RAN vendors, and as such may simplify the need for single-vendor, or in some cases multiple, multi-vendor EMS products in the OAM chain. The model conversion application as described herein may be deployed and/or upgraded dynamically, potentially simplifying the RAN vendor software versioning. In addition, the model conversion application described herein may enable the exposure of “logical” RAN information via a standards-based SME and/or data management and exposure (DME) interface of a non-RT RIC or near-RT RIC. In some examples, the model conversion application described herein may potentially provide the capabilities described herein outside of a non-RT RIC or near-RT RIC, such as to any SMO services, a RAN NSSMF, or other SMO entities.

In some examples, the model conversion application described herein is an rApp or xApp. In some examples, the model conversion application described herein provides generic CM, PM, and FM-related services to other rApps/xApps via the SME interface. In some examples, the model conversion application described herein may use the DME interface instead of, or in addition to, the SME interface. The generic CM services include, for example, configuration read and configuration write. The generic PM services include, for example, performance metric query. The generic PM services include, for example, fault query and notifications, fault acknowledgment, and fault clearing.

In some examples, the model conversion application described herein uses non-RT RIC R1 OAM services to get vendor-specific OAM data. The model conversion application parses and translates the vendor-specific OAM data and converts such data into, for example, a 3GPP/O-RAN standards-based model or alternatively, a non-standard but uniform model. For example, the non-standard uniform model may be an even more advanced, logically-abstracted model, which provides access to direct cell id or neighbor information, rather than accessing this information via multiple object models.

An OAM operations application, such as an rApp/xApp, rather than calling a Non-RT RIC R1 OAM service, uses R1 SME services to invoke the model conversion application to obtain OAM data. Additionally, the model conversion application described herein may provide “logical” RAN information. For example, the model conversion application described herein may provide R1 SME services such as getCellId (or getNCGI in the 5G case), getNeighborhoodRelations, or getPCIPool. Such SME services can be used by any rApp. However, these SME services may be especially useful for porting existing C-SON use cases to rApps. In addition, in some examples, other SMO components, such as a RAN NSSMF, may use the model conversion application described herein to manage non-O-RAN-based RAN nodes.

Typically, the model conversion application described herein requires transport-and protocol-level OAM integration. In some examples, the model conversion application of the present disclosure may implement transport-and protocol-level OAM integration by extending R1 OAM services to provide a tunnel such that the model conversion application may operate as an rApp or xApp that may directly communicate with a vendor node or EMS.

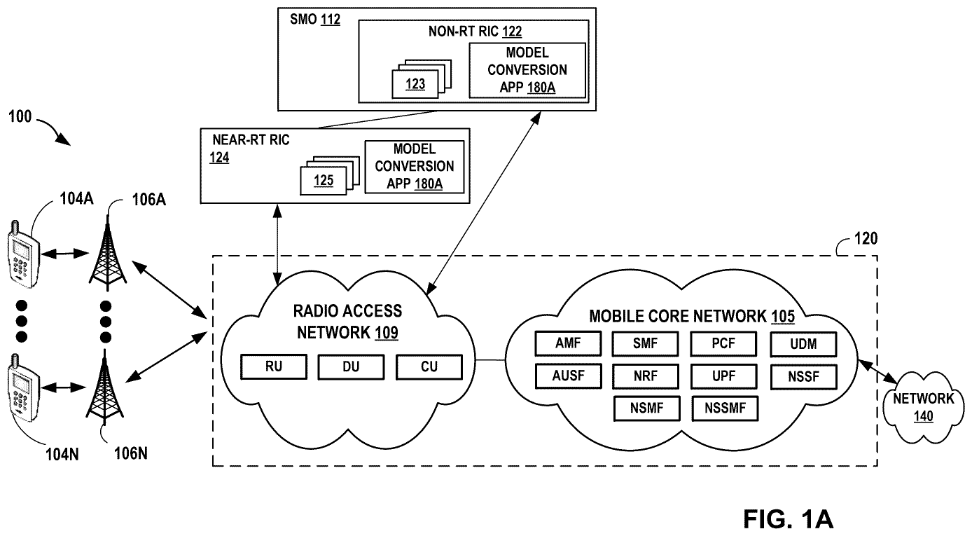

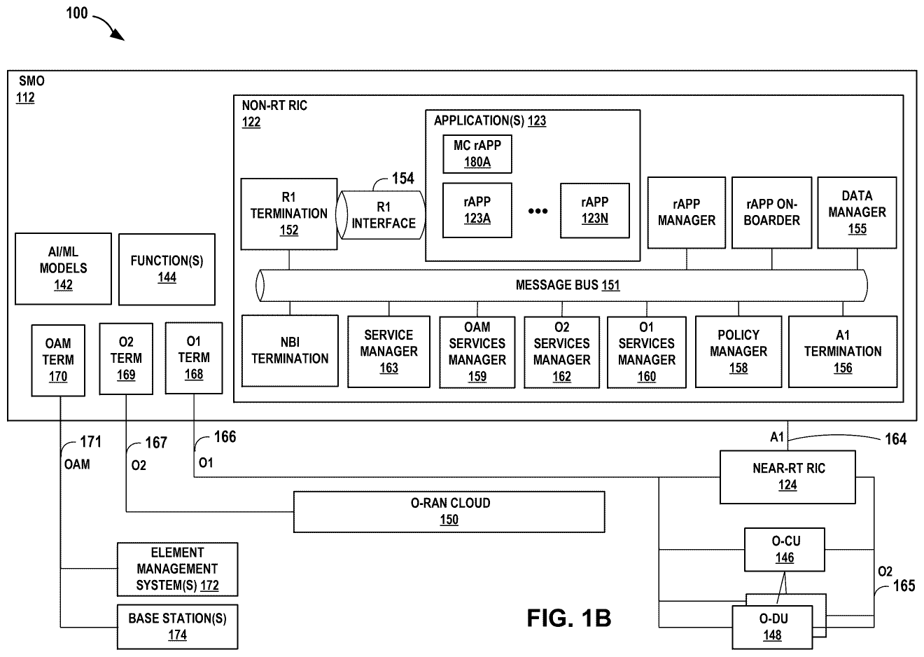

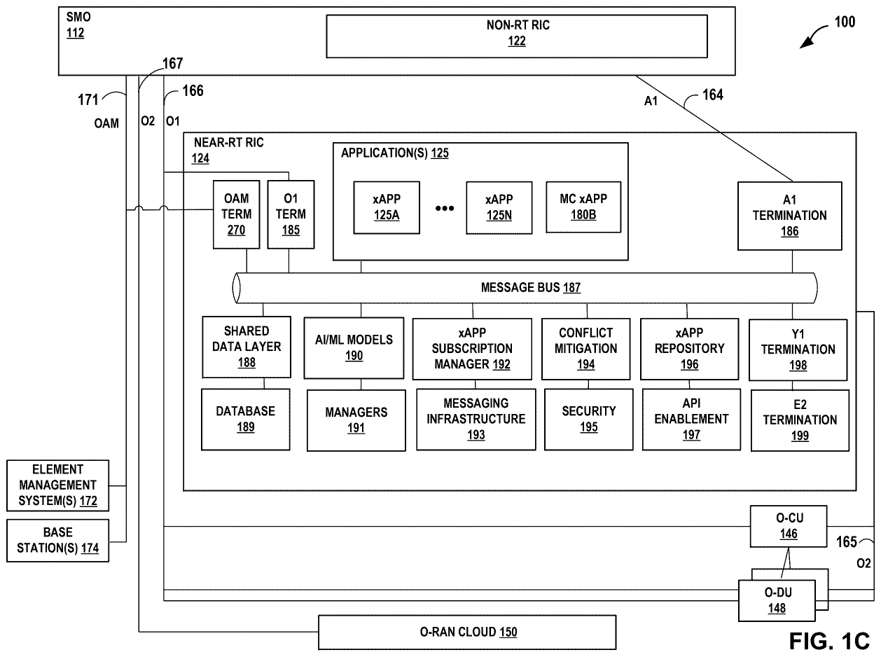

FIG. 1A is a block diagram illustrating an example network system configured to provide compatibility for different data models in a mobile network, in accordance with one or more techniques of the disclosure. In the example illustrated in FIG. 1A, network system 100 includes Service and Management Orchestrator (SMO) 112, non-RT RIC 122, near-RT RIC 124, and mobile network 120. Mobile network 120 includes one or more respective radio access networks (RANs), e.g., RANs 109, and one or more corresponding mobile core networks (or simply “cores”) 105 (collectively, “mobile core networks 105”) that provide user equipment 104A-104N (collectively, “UEs 104”) with access to one or more applications or services provided by data network 140. In some examples, mobile network 120 comprises 5G or xG mobile networks.

UEs 104 may represent smartphones, desktop computers, laptop computers, tablets, smart watches, and/or “Internet-of-Things” (IOT) devices, such as cameras, sensors, televisions, appliances, or the like. As shown in FIG. 1A, mobile network 120 includes a respective RAN 109 that provides network access, data transport, and other services to UEs 104. In some examples, RAN 109 may be an O-RAN, a 5G mobile network RAN, a 4G LTE mobile network RAN, another type of RAN, or a combination of the above. For example, in a 5G-radio access network, RAN 109 comprises a plurality of cell sites (or simply “cells”) that each include radio equipment, such as respective base stations 106A-106N (collectively, “base stations 106”), also known as gNodeBs, to exchange packetized data within a data network to ultimately access one or more applications or services provided by data network 140. Each of base stations 106 is divided into three functional components: radio unit (RU), distributed unit (DU), and central unit (CU), which can be deployed in various configurations. RU manages the radio frequency layer and has antenna arrays of various sizes and shapes. DU performs lower layer protocol processing. CU performs the upper layer protocol processing. Depending on operator and service requirements, base stations 106 can be deployed monolithically, e.g., RU, DU, and CU reside within a cell site, or these functionalities can be distributed across cell sites while the CU resides in an edge cloud site controlling a plurality of distributed DUs. O-RAN is, for example, an approach to networking in which disaggregated functions can be used to deploy mobile fronthaul and midhaul networks. The disaggregated functions can be cloud-based functions.

RAN 109 of mobile network 120 connects to core 105 to exchange packets with a respective data network 140. Core 105 may be a 5G core network, and data network 140 may represent, for example, one or more service provider networks and services, the Internet, third party services, one or more IP-VPNs, an IP-multimedia subsystem, a combination thereof, or other network or combination of networks. In some examples, resources associated with the service provided by a mobile network operator to the tenant may be provided by, or managed by, functions of core 105 and/or components of RAN 109. In some examples, core 105 implements various discrete control plane and user plane functions for network system 100. Examples of 5G control plane functions that may be provided by core 105 include Access Mobility Management Function (AMF) that provides access mobility management services, Session Management Function (SMF) that provides session management services, Policy Control Function (PCF) that provides policy control services, User Data Management (UDM) that provides management of network user data, Network Repository Function (NRF) that provides a repository that can be used to register and discover services in a network operator's network, Authentication Server Function (AUSF) that provides authentication services, Network Slice Selection Function (NSSF), NSMF that may be used to select an instance of an available network slice for use by any of UE devices 104, and Network Slice Subnet Management Function (NSSMF) that provides coordination, management, and orchestration of network slice subnet instances (NSSI). Core 105 may also include User Plane Functions (UPF) that provides packet routing, forwarding and other network data processing functions (e.g., Quality of Service, packet inspection, traffic optimization etc.). Further details on services and functions provided by the 5G core, can be found in 3^{rd} Generation Partnership Project 2021, Technical Specification Group Services and System Aspects; System architecture for the 5G System (5GS); Stage 2 (Release 17), TS 23.501 V17.0.0 (2021-03), which is superseded by 2021, Technical Specification Group Services and System Aspects; System architecture for the 5G System (5GS); Stage 2 (Release 18), TS 23.501 V18.2.2 (2023-07), the entire contents of each of which are hereby incorporated by reference. Further details on the O-RAN architecture can be found in O-RAN Alliance, “O-RAN Architecture Description,” version 7.00, October 2022, the entire contents of which is hereby incorporated by reference.

In some examples, network system 100 is an example of a 4th generation (4G) mobile network, a 5th generation (5G) mobile network, or a 6th generation (6G) mobile network. A network system, such as network system 100, may include a Service Management and Orchestration (SMO) framework offering various framework functions along with a non-RT RIC, configured in accordance with O-RAN standards (“O-RAN architecture”), to manage and/or monitor aspects of a RAN and/or 5G core. The O-RAN architecture may include a non-RT RIC and a near-RT that each executes different functions and services for RAN functions. A non-RT RIC is an orchestration and automation function configured to provide radio resource management, higher layer procedure optimization, policy optimization, and provide guidance, parameters, policies and artificial intelligence (AI) and machine learning (ML) models to support the operation of near-RT RIC functions in the RAN. The non-RT RIC may onboard one or more applications (e.g., rApps) that provide non-real time (e.g., greater than one second) control of RAN elements and their resources, and the near-RT RIC may onboard one or more applications (e.g., xApps) that provide near-real time control of RAN elements and their resources.

The O-RAN architecture includes several interfaces, such as A1, O1, and O2 interfaces, that are each used to provide the functions and services by which the SMO and RIC can configure or direct other components of the RAN. For example, the functions and services of a non-RT RIC may include policy management services and/or enrichment information services for a near-RT RIC that are provided over an A1 interface (collectively referred to herein as “A1 services” because they provided over the A1 interface); OAM services, such as performance management services and configuration management services, for O-RAN management elements that are provided over an O1 interface (referred to herein as “O1 services” because they are provided over the O1 interface); infrastructure management services and deployment management services for resources of an O-RAN cloud that are provided over an O2 interface (referred to herein as “O2 services” because they are provided over the O2 interface), and/or other services, such as SME services (e.g., registration of a service, update of a service registration), DME services, and/or AI/ML services.

As depicted in the example of FIG. 1A, aspects of RAN 109 and/or core 105 may be managed and/or monitored by SMO 112, non-RT RIC 122, and near-RT RIC 124. In some examples, SMO 112, non-RT RIC 122, and near-RT RIC 124 may be operated by the mobile network operator providing 5G services to a tenant. SMO 112 can orchestrate and control management and automation aspects of RAN 109 (e.g., network slicing, management, and orchestration of O-Cloud, etc.). Further, SMO 112 may control aspects of non-RT RIC 122 and near-RT RIC 124. Non-RT RIC 122 can provide non-real-time (e.g., greater than one second) control and optimization of RAN elements and resources such as RUs, DUs, and CUs, workflow management, and policy-based control of applications and features of near-RT RIC 124. Near-RT RIC 124 can provide near-real-time (e.g., milliseconds) control and optimization of RAN elements and resources via fine-grained data collection and actions. As further described in FIG. 1B, non-RT RIC 122 and near-RT RIC 124 may deploy as a highly scalable, microservices based containerized architecture. In some examples, near-RT RIC 124 may be located within an edge or regional cloud.

Non-RT RIC 122 may onboard one or more applications, e.g., applications 123 (e.g., rApps of FIG. 1B) that manage non-real time events within non-RT RIC 122, such as applications that do not require response times of less than one second. Applications 123 may leverage the functionality exposed via the non-RT RIC framework of non-RT RIC 122. Applications 123 may be used to control and manage RAN elements and resources, such as near-RT RIC 124, RAN nodes, and/or resources in the O-RAN cloud. Applications 123 may also utilize network data, performance metrics, and subscriber data to provide recommendations for network optimization and operational guidance (e.g., policies) to one or more applications of near-RT RIC 124. Although illustrated as within non-RT RIC 122, any one or more of applications 123 may be executed by a third party, separate from non-RT RIC 122.

As described further below, non-RT RIC 122 may provide services using management interfaces such as the A1, O1, O2, and OAM interfaces. An A1 interface connects the non-RT RIC 122 and near-RT RIC 124. Non-RT RIC 122 may perform services via the A1 interface, such as policy management services (e.g., creation and update of a policy), ML model management services, and/or enrichment information services. Services performed via the A1 interface are referred to herein as “A1 services.” An O1 interface may include an interface that connects SMO 112 with O-RAN managed elements, such as near-RT RIC 124 and/or RAN nodes (e.g., O-RAN centralized unit (O-CU), O-RAN distributed unit (O-DU)). Non-RT RIC 122 may perform services via the O1 interface, such as configuration management services and performance management services of O-RAN managed elements (e.g., OAM services), fault supervision, file management, heartbeat, trace, physical network function (PNF) discovery, software management, etc.). Services performed via the O1 interface are referred to herein as “O1 services.” An O2 interface may include an interface that connects SMO 112 to resources of the ORAN O-Cloud. The O-Cloud may comprise of one or more physical infrastructure nodes that host O-RAN functions (e.g., virtual network functions), the supporting software components, and the appropriate management and orchestration functions. Non-RT RIC 122 may perform services via the O2 interface, such as services that provide infrastructure management and/or network function deployment of the resources in the O-Cloud (e.g., discovery and administration of O-Cloud resources; Scale-In, Scale-Out of cloud/deployments; Fault, Configuration, Accounting, Performance, and Security (FCAPS) of cloud/deployments, software management of cloud platform/deployments; create/delete deployment and associated allocated O-Cloud resources). Services performed via the O2 interface are referred to herein as “O2 services.” An OAM interface may include an interface that connects SMO 112 with elements or RAN nodes not managed in accordance with O-RAN, such as one or more EMS(s) 172 and base station(s) 174) and/or RAN nodes. Non-RT RIC 122 may perform services via the IAN interface, such as configuration management services and performance management services of non-O-RAN managed elements (e.g., OAM services), fault supervision, file management, heartbeat, trace, physical network function (PNF) discovery, software management, etc.). Services performed via the OAM interface are referred to herein as “OAM services.” Non-RT RIC 122 may also perform other functions and services, such as SME services (e.g., registration of a service, update of a service registration), DME services, AI/ML services, or the like.

In some examples, non-RT RIC 122 and near-RT RIC 124 implement a standardized or standards-specified data model, such as an O-RAN data model, to provide OAM operations for RAN 109. However, RAN 109 may include network devices provided by various vendors, each of which may use a different vendor-specific data model for implementing OAM telemetry and control that may not adhere to 3GPP/O-RAN standards. Supporting the various vendor-specific data models conventionally may require complex configuration in the OAM chain, thereby increasing the cost and maintenance for network operations.

In accordance with the techniques of the disclosure, network system 100 implements a model conversion application that may convert between data models within a RIC for mobile network 120. For example, non-RT RIC 122 implements model conversion application 180A and near-RT RIC 124 implements model conversion application 180B. Using the techniques described herein, model conversion application 180A for non-RT RIC 122 and model conversion application 180B for near-RT RIC 124 for mobile network 120 provide capabilities for converting between the various different data models implemented across network system 100. For convenience, the operation of model conversion application 180A is described below with respect to non-RT RIC 122 of FIG. 1A. However, model conversion application 180B may operate in a substantially similar fashion with respect to near-RT RIC 124.

For example, model conversion application 180A receives, from non-RT RIC 122 via an R1 interface (not depicted in FIG. 1A), a first request specifying one or more first attributes according to a first data model. In some examples, the first request comprises a SME request for OAM data for RAN 109 formulated in accordance with a standardized data model. Model conversion application 180A generates, based at least in part on the one or more first attributes, a second request specifying one or more unique identifiers and one or more first objects according to a second data model. In some examples, the unique identifiers identify nodes of RAN 109, such as one or more EMSs 172 or one or more base stations 174. In some examples, the unique identifiers comprise one or more distinguished names (DNs) corresponding to one or more EMSs 172 or one or more base stations 174. In some examples, the unique identifiers may comprise a vendor-specific identifier for nodes within RAN 109. In some examples, the second request comprises at least one of a CM read request, a PM read request, or an FM read request formulated in accordance with a vendor-specific data model. In some examples, the second request is a request for OAM data from CUs and DUs of RAN 109. Model conversion application 180A sends, to non-RT RIC 122 via the R1 interface, the second request for sending, by non-RT RIC 122, over an OAM interface (not depicted in FIG. 1A) to, e.g., CUs and DUs of RAN 109 for mobile network 120.

Non-RT RIC 122 receives, from CUs and DUs of RAN 109 for mobile network 120, a second response. The second response is responsive to the second request and specifies one or more second objects according to the second data model. In some examples, the second response comprises a CM read response responsive to the CM read request and formulated in accordance with the vendor-specific data model. In some examples, the second response comprises a PM read response responsive to the PM read request and formulated in accordance with the vendor-specific data model. In some examples, the second response comprises an FM read response responsive to the FM read request and formulated in accordance with the vendor-specific data model. Model conversion application 180A receives, from non-RT RIC 122, the second response over the R1 interface. Model conversion application 180A generates, based at least in part on the one or more second objects, a first response, the first response specifying one or more second attributes according to the first data model and responsive to the first request. For example, the first response comprises an SME response responsive to the SME request formulated in accordance with the standardized data model. Model conversion application 180A provides, via the R1 interface, the first response to non-RT RIC 122 to support OAM operations by non-RT RIC 122.

FIG. 1B is a block diagram illustrating further example details of the non-RT RIC 122 of FIG. 1A. In the example illustrated in FIG. 1B, SMO 112 may include non-RT RIC 122, one or more AI/ML models 142, one or more functions 144 (e.g., NSSMF, NFMF, and other functions), and open interfaces, such as O1 termination interface 168, O2 termination interface 169, and OAM termination interface 170. SMO 112 may manage non-RT RIC 122, near-RT RIC 124, O-RAN managed elements (e.g., centralized unit (O-CU) 146, O-RAN decentralized unit (O-DU) 148 of one or more base stations), and resources in O-RAN cloud 150, as well as additional managed resources and elements that do not conform to O-RAN, such as one or more element management systems 172 and base stations 174.

Non-RT RIC 122 may provide non-real-time (e.g., greater than one second) control and optimization of RAN elements and resources such as RUs, DUs, and CUs, workflow management, and policy-based control of applications and features of near-RT RIC 124. Non-RT RIC 122 may be deployed as a highly scalable, microservices based containerized architecture. In this example, non-RT RIC 122 may onboard, deploy, and/or terminate one or more applications, e.g., rApp 123A through rApp 123N (collectively “applications 123”). Applications 123 may represent applications that leverage the functionality exposed via the framework of non-RT RIC 122. Applications 123 may provide non-RT RIC 122 with non-real time (e.g., greater than one second) control of RAN elements and their resources. Applications 123 may provide services for radio resource management, higher layer procedure optimization, policy optimization, and providing guidance, parameters, policies, and AI/ML models to support the operation of RAN functions.

For example, applications 123 may provide A1 services that provide and facilitate RAN operations and optimization of near-RT RIC 124, such as providing operational guidance (e.g., policies), enrichment information (e.g., forecasts), and AI/ML services. A1 services may include policy management services such as creating, updating, and/or deleting of A1 policies; receiving policy feedback; querying policy types, identifiers, and status; defining which policy types are supported by near-RT RIC 124; and registering applications (xApps) of near-RT RIC 124 to specific policy types. A1 services may include enrichment information services, such as providing data for model training of AI/ML models, such as forecasts and/or data analytics.

Applications 123 may provide O1 services that provide configuration management or performance management of O-RAN managed entities, such as near-RT RIC 124 and/or RAN nodes, e.g., O-CU 146, O-DU 148 (also referred to herein as “E2 nodes”). O1 services may provide configuration management services to create, update, and/or delete configurations to O-RAN managed entities. For example, configuration management services may include provisioning operations (e.g., for NSS and NF provisioning) to create a managed object instance (MOI), obtain MOI attributes, modify MOI attributes, and/or delete the MOI. O1 services may also provide performance management services that monitor the status of elements or components in the O-RAN managed entities. For example, non-RT RIC 122 may create, modify, or delete performance management jobs to receive performance metrics, or send heartbeat messages to monitor the status and/or availability of services of RAN nodes or to send trace messages to monitor link failures. O1 services may also provide file management, such as to push files to the RAN nodes (e.g., software updates, beamforming configuration files, ML models, security certificates, etc.).

Applications 123 may provide O2 services that provide infrastructure management and/or network function deployment of resources in O-RAN cloud 150 (also referred to herein as “O-Cloud 150”). O2 services may provide discovery and administration of O-Cloud resources; Scale-In, Scale-Out of cloud/deployments (e.g., deploying resources with more or less processors); FCAPS of cloud/deployments, software management of cloud platform/deployments; create/delete deployment and associated allocated O-Cloud resources.

Applications 123 may also provide OAM services that provide configuration management or performance management of entities not managed in accordance with O-RAN, such as one or more EMS(s) 172 and base station(s) 174. OAM services may provide configuration management services to create, update, and/or delete configurations to non-O-RAN managed entities. For example, configuration management services may include provisioning operations (e.g., for NSS and NF provisioning) to create a managed object instance (MOI), obtain MOI attributes, modify MOI attributes, and/or delete the MOI. OAM services may also provide performance management services that monitor the status of elements or components in the non-O-RAN managed entities. For example, non-RT RIC 122 may create, modify, or delete performance management jobs to receive performance metrics, or send heartbeat messages to monitor the status and/or availability of services of RAN nodes or to send trace messages to monitor link failures. OAM services may also provide file management, such as to push files to the RAN nodes (e.g., software updates, beamforming configuration files, ML models, security certificates, etc.).

Applications 123 may provide SME services, DME services, and/or other services. SME services may provide services that enable services provided over an internal interface (R1 interface 154) of non-RT RIC 122 and their exposure and extensibility through services including bootstrap, service registration/deregistration or updates to service registration, service discovery or notification, heartbeat, authentication, authorization, etc. DME services may include services that manage data and their exposure between applications 123. For example, applications 123 may have different functions, such as application 123A configured to collect and analyze data, application 123B configured to generate an ML model based on the results of the analysis, and application 123N configured to make a prediction or inference using the ML model and/or to generate controls for RAN nodes based on the prediction or inference. DME services may manage the data shared between applications 123, such as the collection of data, the processing of the data, and/or the advertisement of the data.

Non-RT RIC 122 may include one or more managers to process the A1, O1, O2, SME, DME services, and other services. For example, non-RT RIC 122 may include a policy manager 158, O1 services manager 160, O2 services manager 162, service manager 163, and data manager 155. Non-RT RIC 122 may include other managers, such as an application manager and an application on-boarder, that are configured to manage the installation and deployment of applications 123.

Policy manager 158 is configured to control the deployment of policies (e.g., A1 services). For example, in response to receiving requests for A1 services from applications 123 via R1 interface 154, R1 interface 154 sends the requests to policy manager 158 via message bus 151. Policy manager 158 may process the A1 services and may send the A1 services to A1 termination 156 via message bus 151, which provides the A1 services to near-RT RIC 124 via A1 interface 164. In some examples, the A1 interface may implement an A1AP application protocol based on the O-RAN specifications.

O1 services manager 160 is configured to control the deployment of O1 services for monitoring the performance of near-RT RIC 124 and/or RAN nodes (e.g., O-CU 146, O-DU 148). For example, in response to receiving requests for O1 services for monitoring the performance of near-RT RIC 124 from applications 123 via R1 interface 154, R1 interface 154 sends the requests to O1 services manager 160 via message bus 151. O1 services manager 160 may process the O1 services and may send the O1 services to O1 termination 168, which provides the O1 services to near-RT RIC 124 via O1 interface 166. In some examples, the O1 interface may implement REST/HTTPS APIs and/or NETCONF.

O1 services manager 160 is additionally, or alternatively, configured to control the deployment of O1 services for the configuration of near-RT RIC 124 and/or RAN nodes. For example, in response to receiving requests for O1 services for the configuration of near-RT RIC 124 from applications 123 via R1 interface 154, R1 interface 154 sends the requests to O1 services manager 160. O1 services manager 160 may process the O1 services and may send the O1 services to O1 termination 168, which provides the O1 services to near-RT RIC 124 via O1 interface 166.

O2 services manager 162 may be configured to control the deployment of O2 services for monitoring the performance of resources of O-Cloud 150. For example, in response to receiving requests for O2 services for monitoring the performance of resources within O-Cloud 150 via R1 interface 154, R1 interface 154 sends the request to O2 services manager 162. O2 services manager 162 may process the O2 services and may send the O2 services to O2 termination 169, which provides the O2 services to resources of O-Cloud 150 via O2 interface 167.

O2 services manager 162 may additionally, or alternatively, be configured to control the deployment of O2 services for the configuration of resources of O-Cloud 150. For example, in response to receiving requests for O2 services for configuring resources within O-Cloud 150 from applications 123 via R1 interface 154, R1 interface 154 sends the requests to O2 services manager 162. O2 services manager 162 may process the O2 services and may send the O2 services to O2 termination 169, which provides the O2 services to resources of O-Cloud 150 via O2 interface 167.

OAM services manager 159 is configured to control the deployment of OAM services for monitoring the performance of near-RT RIC 124 and/or RAN nodes that do not employ O-RAN (e.g., EMS(s) 172 and base stations 174). For example, in response to receiving requests for OAM services for monitoring the performance of near-RT RIC 124 from applications 123 via R1 interface 154, R1 interface 154 sends the requests to OAM services manager 159 via message bus 151. OAM services manager 159 may process the OAM services and may send the OAM services to OAM termination 170, which provides the OAM services to near-RT RIC 124 via OAM interface 171. In some examples, OAM interface 171 may implement REST/HTTPS APIs and/or NETCONF.

OAM services manager 159 is additionally, or alternatively, configured to control the deployment of OAM services for the configuration of near-RT RIC 124 and/or RAN nodes that do not employ O-RAN (e.g., EMS(s) 172 and base stations 174). For example, in response to receiving requests for OAM services for the configuration of near-RT RIC 124 from applications 123 via R1 interface 154, R1 interface 154 sends the requests to OAM services manager 159. OAM services manager 159 may process the OAM services and may send the OAM services to OAM termination 170, which provides the OAM services to near-RT RIC 124 via OAM interface 171. Typically, non-RT RIC 122 employs OAM termination 170 to provide OAM services to RAN elements that do not support O-RAN or O1 interface 166, such as EMS(s) 172 and base station(s) 172).

In some examples, R1 interface 154 also exposes applications 123 to SME services, DME services, and/or other services. For example, in response to receiving requests for SME services from applications 123 via R1 interface 154, R1 interface 154 sends the requests to service manager 163. Service manager 163 may process the SME services (e.g., register/update a service) and may send the SME services to R1 termination 152, which provides the SME services to applications 123 via R1 interface 154 (e.g., sending response to application regarding service registration, update, or discovery). Similarly, in response to receiving requests for DME services from applications 123 via R1 interface 154, R1 interface 154 sends the requests to data manager 155. Data manager 155 may process the DME services and may send the DME services to R1 termination 152, which provides the DME services to applications 123 via R1 interface 154 (e.g., sending data from application configured as a data producer to application configured as a data consumer).

R1 interface 154 may also expose applications 123 to slice subnet management services, such as RAN NSSMF interfaces to retrieve slice service level agreements (SLAs) and slice topologies, and/or slice management, SLA, and slice performance management notifications to applications 123.

In some examples, SMO 112 and non-RT RIC 122 implement a standardized or standards-specified data model, such as an O-RAN data model, to provide OAM operations for RAN 109. With respect to the O-RAN OAM model, a managed element (ME) is a device, service, or application that supports communication over management interface(s) to a management entity (such as SME 112 or Non-RT RIC 122) for purposes of control and monitoring. A managed function (MF) instance is managed using a management interface exposed by its containing ME instance. The O-RAN OAM architecture adds an interface for OAM operations, labeled “O1.” O1 is the interface between the O-RAN ME and the management entity.

O-RAN specifies a number of different data models for OAM operations. SMO 112 and non-RT RIC 122 may support the use of a single O-RAN OAM model or multiple O-RAN OAM models. For example, in an O-RAN flat management architecture model, all MFs comprising the O-RAN architecture are also MEs and expose an O1 interface to SMO 112. In an O-RAN hierarchical management architecture model, a higher level ME is used to manage a subnetwork of Mes, such as where a DU manages an RU using a front-haul M-plane interface. In an O-RAN hybrid management architecture model, the RU is managed partially by the DU and partially by SMO 112. The O1 interface may be terminated directly on SMO 112 in a flat model, or in a hierarchical model, the O1 interface may be terminated on a ME which manages other O-RAN MFs.

Additional information regarding the O-RAN data model for OAM data in set forth in O-RAN Operations and Maintenance Interface 4.0, O-RAN.WG1.O1-Interface.0-v04.00, O-RAN Alliance, February 2021, available at https://specifications.o-ran.org/specifications, and O-RAN Operations and Maintenance Architecture 4.0, O-RAN.WG1.OAM-Architecture-v04.00, O-RAN Alliance, February 2021, available at https://specifications.o-ran.org/specifications, the entire content of each of which is hereby incorporated by reference.

In accordance with the techniques of the disclosure, model conversion application 180A may convert between data models within non-RT RIC 122 for mobile network 120. Using the techniques described herein, model conversion application 180A for non-RT RIC 122 provides capabilities for converting between the various different data models implemented across network system 100. In the example of FIG. 1B, model conversion application 180A is an rApp executed by non-RT RIC 122.

For example, model conversion application 180A receives, from non-RT RIC 122 via R1 interface 154, a first request specifying one or more first attributes according to a first data model. In some examples, the first request comprises a SME request for OAM data for RAN 109 formulated in accordance with a standardized data model. Model conversion application 180A generates, based at least in part on the one or more first attributes, a second request specifying one or more unique identifiers and one or more first objects according to a second data model. In some examples, the unique identifiers identify one or more EMSs 172 or one or more base stations 174. In some examples, the unique identifiers comprise one or more DNs corresponding to one or more EMSs 172 or one or more base stations 174. In some examples, the second request comprises at least one of a CM read request, a PM read request, or an FM read request formulated in accordance with a vendor-specific data model. In some examples, the second request is a request for OAM data from CUs and DUs of RAN 109. Model conversion application 180A sends, to non-RT RIC 122 via R1 interface 154, the second request for sending, by non-RT RIC 122, over OAM interface 171 to, e.g., one or more EMS(s) 172 and base station(s) 174 of RAN 109 for mobile network 120.

Non-RT RIC 122 receives, from one or more EMS(s) 172 and base station(s) 174 of RAN 109 of RAN 109 for mobile network 120, a second response. The second response is responsive to the second request and specifies one or more second objects according to the second data model. In some examples, the second response comprises a CM read response responsive to the CM read request and formulated in accordance with the vendor-specific data model. In some examples, the second response comprises a PM read response responsive to the PM read request and formulated in accordance with the vendor-specific data model. In some examples, the second response comprises an FM read response responsive to the FM read request and formulated in accordance with the vendor-specific data model. Model conversion application 180A receives, from non-RT RIC 122, the second response over R1 interface 154. Model conversion application 180A generates, based at least in part on the one or more second objects, a first response, the first response specifying one or more second attributes according to the first data model and responsive to the first request. For example, the first response comprises an SME response responsive to the SME request formulated in accordance with the standardized data model. Model conversion application 180A provides, via R1 interface 154, the first response to non-RT RIC 122 to support OAM operations by non-RT RIC 122.

In some examples, model conversion application 180A may register a conversion service for the various different models (standards-specified or vendor-specific) supported by model conversion application 180A. Other applications (referred to as “operations applications” herein), may access the support service to take advantage of the model conversion capabilities of model conversion application 180A. In some examples, these “operations applications” may be any other rApp 123 of non-RT RIC 122 or xApps 125 of near-RT RIC 124 of FIG. 1C. For example, rApps 123 or xApps 125 may be one or more OAM management entities that consume OAM data of devices of RAN 109 so as to provide management of one or more MFs or MEs. As described herein, model conversion application 180A receives, from the operations application via R1 interface 154, first information according to a first data model, such as an SME request for OAM information formulated according to a standards-based, O-RAN data model. Model conversion application 180A generates, based at least in part on the first information, second information according to a second data model. For example, model conversion application 180A generates a CM read request for OAM information formulated according to a vendor-specific data model. In other examples, model conversion application 180A generates a PM read request or an FM read request formulated according to a vendor-specific data model. Model conversion application 180A sends, to the operations application via R1 interface 154, the second information.

For example, model conversion application 180A receives, from non-RT RIC 122 via R1 interface 154, data specifying a device inventory for RAN 109. The device inventory comprises a list of devices within RAN 109 and make, model, and version information for the devices. Model conversion application 180A determines that at least one device specified by the device inventory corresponds to a data model supported by model conversion application 180A. Model conversion application 180A sends a SME request to non-RT RIC 122, the SME request configured to register a support service for the at least one device.

Subsequently, non-RT RIC 122 receives, via R1 interface 154 from an operations application such as rApp 123A, a request for information specifying available services of non-RT RIC 122. Non-RT RIC 122 sends, via R1 interface 154 and to rApp 123A, information specifying available services. The information specifying available services indicates an availability of one or more support services for one or more devices of RAN 109.

With respect to the foregoing example, rApp 123A is an OAM management entity for one or more EMS(s) 172 and base station(s) 174 of RAN 109 and receives information specifying a support service for one or more EMS(s) 172 and base station(s) 174 of RAN 109. In this example, model conversion application 180A receives, from rApp 123A via R1 interface 154, an SME request for OAM information formulated according to a standards-based, O-RAN data model. Model conversion application 180A generates a CM read request for OAM information formulated according to a vendor-specific data model used by one or more EMS(s) 172 and base station(s) 174 of RAN 109. In other examples, model conversion application 180A generates a PM read request or an FM read request formulated according to a vendor-specific data model used by one or more EMS(s) 172 and base station(s) 174 of RAN 109. Model conversion application 180A sends, to rApp 123A via R1 interface 154, the second information. rApp 123A may send, via R1 interface 154, the CM read request for OAM information to non-RT RIC 122 for sending, via OAM interface 171, to one or more EMS(s) 172 and base station(s) 174 of RAN 109. Non-RT RIC 122, rApp 123A, and model conversion application 180A may operate in a substantially similar fashion to convert responses from one or more EMS(s) 172 and base station(s) 174 of RAN 109 including OAM information formulated according to the vendor-specific data model into responses including OAM information formulated according to the standards-based, O-RAN data model. In this fashion, model conversion application 180A operates to convert OAM information formulated according to a first data model into OAM information formulated according to a second data model, thereby facilitating the use by non-RT RIC 122 and rApp 123A of standards-based OAM data models while maintaining support of devices of RAN 109 that may use various vendor-specific OAM data models.

FIG. 1C is a block diagram illustrating further example details of the Near-RT RIC of FIG. 1A. In the example illustrated in FIG. 1C, near-RT RIC 124 includes shared data layer 188, database 189, one or more AI/ML models 190, managers 191, xApp subscription manager 192, messaging infrastructure 193, conflict mitigation 194, security 195, xApp repository 196, message bus 187, API enablement 197, and open interfaces, such as O1 termination 185, OAM termination 270, A1 termination 186, Y1 termination 198, and E2 termination 199.

Near-RT RIC 124 can provide near-real-time (e.g., milliseconds) control and optimization of RAN elements and resources, such as O-CU 146, O-DU 148, one or more EMS(s) 172, and/or base station(s) 174, via fine-grained data collection and actions performed via E2 interface 199. For example, near-RT RIC 124 may onboard one or more applications 125 (e.g., xApps 125A-125N of FIG. 1C, collectively, “xApps 125”) that provide near-real time control of RAN elements and their resources.

Near-RT RIC 124 may be deployed as a highly scalable, microservices based containerized architecture. Near-RT RIC 124 may onboard one or more applications, e.g., applications 125 (e.g., xApps 125) that manage near-real time events within near-RT RIC 124. Applications 125 may leverage the functionality exposed via the near-RT RIC framework of near-RT RIC 124. Near-RT RIC 124 may enforce policies received from applications 123 of non-RT RIC 122 and may provide policy feedback to non-RT RIC 122. Although illustrated as within near-RT RIC 124, any one or more of applications 125 may be executed by a third party, separate from near-RT RIC 124.

Shared Data Layer 188 and database 189 enable near-RT RIC 124 to maintain and expose RAN/UE information and other information required to support specific use cases. In some examples, database 189 maintains a list of UEs and associated data, and perform tracking and correlation of the UE identities associated with the connected E2 Nodes. In some examples, database 189 maintains configurations and near real-time information relating to connected E2 Nodes and the mappings between them. In some examples, Shared Data Layer 188 and database 189. Such information may be generated and accessed by near-RT RIC 124 or authorized xApps 125. Shared Data Layer 188 provides SDL services for xApps 125, which can be used to subscribe to database notifications and to read, write and modify information stored on database 189. Use-case specific information may be exposed using the services provided by Shared Data Layer 188.

Managers 191 include OAM management, which provides fault, configuration, accounting, performance, file, security and other management plane services. Managers 191 of near-RT RIC 124 provide several capabilities to support OAM management services. For example, managers 191 provide fault management, including Near-RT RIC Fault Supervision MnS over the O1 interface. Further, managers 191 provide configuration management, including Near-RT RIC Provisioning MnS over the O1 interface.

In some examples, managers 191 perform logging, tracing, and metrics collection functions. Logging is to capture information needed to operate, troubleshoot and report on the performance of near-RT RIC 124 and its constituent components. Log records may be viewed and consumed directly by users and systems, indexed and loaded into a data storage, and used to compute metrics and generate reports. Near-RT RIC components log events according to a common logging format. Different logs can be generated (e.g., audit log, metrics log, error log and debug log). Tracing mechanisms are used to monitor the transactions or a workflow. An example subscription workflow can be broken into two traces namely, a subscription request trace followed by a response trace. Individual traces can be analyzed to understand timing latencies as the workflow traverses a particular Near-RT RIC component. Metrics are collected and reported for performance and fault management specific to each xApp logic and other internal functionalities are collected and published for authorized consumer (e.g., SMO).

Near-RT RIC 124 includes xApp subscription manager 192. xApp subscription manager 192 enables near-RT RIC 124 to handle subscription requests from different xApps 125 for, e.g., E2-related data, and provides unified data distribution to xApps 125 for those data. xApp subscription manager 192, in some examples, manages subscriptions from xApps to E2 nodes. xApp subscription manager 192 may enforce authorization of policies controlling xApp 125 access to messages. Further, xApp subscription manager 192 enables merging of identical subscriptions from different xApps 125 into a single subscription toward an E2 Node.

Conflict mitigation 194 enables near-RT RIC 124 to detect and resolve potentially overlapping or conflicting requests from multiple xApps 125. In the context of near-RT RIC 124, conflict mitigation 194 addresses conflicting interactions between different xApps 125. An application may change one or more parameters with the objective of optimizing a specific metric. Conflict mitigation 194 may reduce, mitigate, or avoid instances wherein xApps 125 chose or configure objectives such that they result in conflicting actions.

Messaging infrastructure 193 enables near-RT RIC 124 with low-latency message delivery between Near-RT RIC internal endpoints. Messaging infrastructure 193 supports registration of endpoints, wherein endpoints register themselves to messaging infrastructure 193. Messaging infrastructure 193 further supports discovery of endpoints, wherein endpoints are discovered by messaging infrastructure 193 initially and registered to messaging infrastructure 193. Messaging infrastructure 193 also supports deletion of endpoints, wherein endpoints are deleted once they are not used anymore. Messaging infrastructure 193 may provide an API for sending messages to messaging infrastructure 193 and an API for receiving messages from messaging infrastructure 193. Messaging infrastructure 193 supports multiple messaging modes, e.g., point-to-point mode (e.g., message exchange among endpoints), publish/subscribe mode (e.g., real-time data dispatching from E2 termination 199 to multiple subscriber xApps 125). Messaging infrastructure 193 provides message routing, namely according to the message routing information, messages can be dispatched to different endpoints. Messaging infrastructure 193 supports message robustness to avoid data loss during a messaging infrastructure outage/restart or to release resources from the messaging infrastructure once a message is outdated.

Near-RT RIC 124 includes security 195. Security 195 prevent malicious xApps 125 from abusing radio network information (e.g., exporting to unauthorized external systems) and/or control capabilities over RAN functions.

Near-RT RIC 124 includes termination for various interfaces, including E2 termination 199, A1 termination 186, O1 termination 185, OAM termination 270, and Y1 termination 198. E2 termination 199 enables termination of an E2 interface. E2 termination 199 may terminate an SCTP connection from each E2 Node. E2 termination 199 may also route messages from xApps 125 through the SCTP connection to an E2 Node. E2 termination 199 may further decode the payload of an incoming ASN.1 message enough to determine message type. In some examples, E2 termination 199 handles incoming E2 messages related to E2 connectivity and receives and responds to an E2 Setup Request from an E2 Node. Furthermore, E2 termination 199 may notify xApps 125 of a list of RAN functions supported by an E2 Node based on information derived from the E2 Setup and RIC Service Update procedures, and may notify the newly connected E2 Node of the list of accepted functions.

A1 termination 186 enables termination of the A1 interface. A1 termination 186 provides a generic API by means of which Near-RT RIC 124 can receive and send messages via an A1 interface. These include, e.g., A1 policies and enrichment information received from Non-RT RIC 122, or A1 policy feedback sent towards Non-RT RIC 122. A1 termination 186 may further send an A1 policy that is set or updated by Non-RT RIC 122 to suitable xApp(s) 125 based on a list of candidate xApps 125 provided by xApp Repository 196.

O1 termination 185 enables termination of O1 interface 166. Near-RT RIC 124 communicates with SMO 112 via O1 interface 166 and exposes O1-related management services from Near-RT RIC 124. For O1 management services (MnS), near-RT RIC 124 is an MnS producer and SMO 112 is an MnS consumer. Near-RT RIC 124 exposes provisioning management services from Near-RT RIC 124 to an O1 provisioning management service consumer, translates O1 management services to internal APIs of near-RT RIC 124, exposing FM services to report faults and events from near-RT RIC 124 to an O1 FM service consumer, exposes PM services to report bulk and real-time PM data from near-RT RIC 124 to an O1 PM service consumer, exposes file management services to download ML files, software files, etc. and upload log/trace files to/from file MnS consumer, and exposes communication surveillance services to the O1 communication surveillance service consumer.

OAM termination 270 enables termination of OAM interface 171. Near-RT RIC 124 communicates with SMO 112 via OAM interface 171 and exposes OAM-related management services from Near-RT RIC 124. For OAM management services (MnS), near-RT RIC 124 is an MnS producer and SMO 112 is an MnS consumer. Near-RT RIC 124 exposes provisioning management services from Near-RT RIC 124 to an OAM provisioning management service consumer, translates OAM management services to internal APIs of near-RT RIC 124, exposing FM services to report faults and events from near-RT RIC 124 to an OAM FM service consumer, exposes PM services to report bulk and real-time PM data from near-RT RIC 124 to an OAM PM service consumer, exposes file management services to download ML files, software files, etc. and upload log/trace files to/from file MnS consumer, and exposes communication surveillance services to the OAM communication surveillance service consumer. Typically, near-RT RIC 124 employs OAM termination 270 to provide OAM services to RAN elements that do not support O-RAN or O1 interface 166, such as EMS(s) 172 and base station(s) 172).

Y1 termination 198 enables termination of the Y1 interface. Y1 termination 198 provides support for exposing RAN analytics information from Near-RT RIC 124 to Y1 consumers.

Near-RT RIC 124 may include one or more managers to process the O1, A1, Y1, and E2 services, and other services. Near-RT RIC 124 may include other managers, such as an application manager and an application on-boarder, that are configured to manage the installation and deployment of applications 125.

API enablement 197 provide APIS for near-RT RIC 124. The near-RT RIC APIs can be categorized based on the interaction with near-RT RIC 124 and can be related to E2-related services, A1-related services, Management related services, and SDL services. This functionality provides support for registration, discovery and consumption of near-RT RIC APIs within the near-RT RIC scope. In particular, API enablement 197 provides services including repository and registry services for near-RT RIC APIs, services that allow discovery of the registered near-RT RIC APIs, services to authenticate xApps 125 for use of the near-RT RIC APIs, services that enable generic subscription and event notification, and functionality to avoid compatibility clashes between xApps 125 and the services they access. In some examples, API enablement 197 provides API enablement services that are accessed by xApps 125 via one or more enablement APIs.

AI/ML models 190 enables near-RT RIC 124 with data pipelining, model management, training and inference, which constitute complete AI/ML workflow support for xApps 125 to implement AI/ML algorithms. xApps 125 may use none, part, or all of this functionality, depending on its design. In some examples, AI/ML models 190 include data pipelining, which performs data ingestion and preparation for xApps 125. AI/ML models 190 may provide generic and use case-independent capabilities to AI/ML-based xApps 125 that may be useful to multiple use cases. The input data for training may come from an xApp-specific space (e.g., dedicated space in database).

xApp Repository 196 maintaining a list of candidate xApp(s) to A1 Termination 186 for sending A1 policy or policy update to suitable xApp(s) 125 based on policy type and operator policies. In addition, xApp Repository 196 maintains the policy types supported in near-RT RIC 124. The supported policy types are based on policy types supported by the registered xApps 125 and operator policies. Further, xApp Repository 196 performs xApp access control to requested A1-EI type based on operator policies.

Much as described above with respect to FIG. 1B, near-RT RIC 124 implements a standardized or standards-specified data model, such as an O-RAN data model, to provide OAM operations for RAN 109. In accordance with the techniques of the disclosure, model conversion application 180B may convert between data models within near-RT RIC 124 for mobile network 120. Using the techniques described herein, model conversion application 180B for near-RT RIC 124 provides capabilities for converting between the various different data models implemented across network system 100. In the example of FIG. 1C, model conversion application 180B is an xApp executed by near-RT RIC 124. Model conversion application 180B may operate in a substantially similar fashion to provide data model conversion operations for near-RT RIC 124 and xApps 125 as model conversion application 180A provides data model conversion operations for non-RT RIC 122 and xApps 123 described above with respect to FIG. 1B.

It should be noted that the architecture of near-RT RIC 124 of FIG. 1C is somewhat different than the architecture of non-RT RIC 122 of FIG. 1B. For example, O-RAN standards do not presently set forth a formal SME definition for the near-RT RIC use case. Nevertheless, near-RT RIC 124 may implement model conversion application 180B as an xApp which operates in a substantially similar fashion as described above with respect to non-RT RIC 122 and model conversion application 180A. An example implementation of model conversion application 180B, as implemented for the near-RT RIC use case, is described below.

For example, model conversion application 180B receives, from near-RT RIC 124 via message bus 187, a first request specifying one or more first attributes according to a first data model. In some examples, the first request comprises a SME request for OAM data for RAN 109 formulated in accordance with a standardized data model. Model conversion application 180B generates, based at least in part on the one or more first attributes, a second request specifying one or more unique identifiers and one or more first objects according to a second data model. In some examples, the unique identifiers identify one or more EMSs 172 or one or more base stations 174. In some examples, the unique identifiers comprise one or more DNs corresponding to one or more EMSs 172 or one or more base stations 174. In some examples, the second request comprises a CM read request, a PM read request, or an FM read request formulated in accordance with a vendor-specific data model. In some examples, the second request is a request for OAM data from CUs and DUs of RAN 109. Model conversion application 180B sends, to near-RT RIC 124 via R1 interface 152, the second request for sending, by near-RT RIC 124, over OAM interface 171 to, e.g., one or more EMS(s) 172 and base station(s) 174 of RAN 109 for mobile network 120.

Near-RT RIC 124 receives, from one or more EMS(s) 172 and base station(s) 174 of RAN 109 of RAN 109 for mobile network 120, a second response. The second response is responsive to the second request and specifies one or more second objects according to the second data model. In some examples, the second response comprises a CM read response responsive to the CM read request and formulated in accordance with the vendor-specific data model. In some examples, the second response comprises a PM read response responsive to the PM read request and formulated in accordance with the vendor-specific data model. In some examples, the second response comprises an FM read response responsive to the FM read request and formulated in accordance with the vendor-specific data model. Model conversion application 180B receives, from near-RT RIC 124, the second response over message bus 187. Model conversion application 180B generates, based at least in part on the one or more second objects, a first response, the first response specifying one or more second attributes according to the first data model and responsive to the first request. For example, the first response comprises an SME response responsive to the SME request formulated in accordance with the standardized data model. Model conversion application 180B provides, via message bus 187, the first response to near-RT RIC 124 to support OAM operations by near-RT RIC 124.

In some examples, model conversion application 180B may register a conversion service for the various different models (standards-specified or vendor-specific) supported by model conversion application 180B. Other applications (referred to as “operations applications” herein), may access the support service to take advantage of the model conversion capabilities of model conversion application 180B. In some examples, these “operations applications” may be any other rApp 123 of non-RT RIC 122 of FIG. 1B or xApps 125 of near-RT RIC 124. For example, rApps 123 or xApps 125 may be one or more OAM management entities that consume OAM data of devices of RAN 109 so as to provide management of one or more MFs or MEs. As described herein, model conversion application 180B receives, from the operations application via message bus 187, first information according to a first data model, such as an SME request for OAM information formulated according to a standards-based, O-RAN data model. Model conversion application 180B generates, based at least in part on the first information, second information according to a second data model. For example, model conversion application 180B generates a CM read request for OAM information formulated according to a vendor-specific data model. In other examples, model conversion application 180B generates a PM read request or an FM read request formulated according to a vendor-specific data model. Model conversion application 180B sends, to the operations application via message bus 187, the second information.

For example, model conversion application 180B receives, from near-RT RIC 124 via message bus 187, data specifying a device inventory for RAN 109. The device inventory comprises a list of devices within RAN 109 and make, model, and version information for the devices. Model conversion application 180B determines that at least one device specified by the device inventory corresponds to a data model supported by model conversion application 180B. Model conversion application 180B sends a SME request to near-RT RIC 124, the SME request configured to register a support service for the at least one device.

Subsequently, near-RT RIC 124 receives, via message bus 187 from an operations application such as xApp 125A, a request for information specifying available services of near-RT RIC 124. Near-RT RIC 124 sends, via message bus 187 and to xApp 125A, information specifying available services. The information specifying available services indicates an availability of one or more support services for one or more devices of RAN 109.

With respect to the foregoing example, xApp 125A is an OAM management entity for one or more EMS(s) 172 and base station(s) 174 of RAN 109 and receives information specifying a support service for one or more EMS(s) 172 and base station(s) 174 of RAN 109. In this example, model conversion application 180B receives, from xApp 125A via message bus 187, an SME request for OAM information formulated according to a standards-based, O-RAN data model. Model conversion application 180B generates a CM read request for OAM information formulated according to a vendor-specific data model used by one or more EMS(s) 172 and base station(s) 174 of RAN 109. In other examples, model conversion application 180B generates a PM read request or an FM read request formulated according to a vendor-specific data model used by one or more EMS(s) 172 and base station(s) 174 of RAN 109. Model conversion application 180B sends, to xApp 125A via message bus 187, the second information. xApp 125A may send, via message bus 187, the CM read request for OAM information to near-RT RIC 124 for sending, via OAM interface 171, to one or more EMS(s) 172 and base station(s) 174 of RAN 109. Near-RT RIC 124, xApp 125A, and model conversion application 180B may operate in a substantially similar fashion to convert responses from one or more EMS(s) 172 and base station(s) 174 of RAN 109 including OAM information formulated according to the vendor-specific data model into responses including OAM information formulated according to the standards-based, O-RAN data model. In this fashion, model conversion application 180B operates to convert OAM information formulated according to a first data model into OAM information formulated according to a second data model, thereby facilitating the use by near-RT RIC 124 and rApp 123A of standards-based OAM data models while maintaining support of devices of RAN 109 that may use various vendor-specific OAM data models.

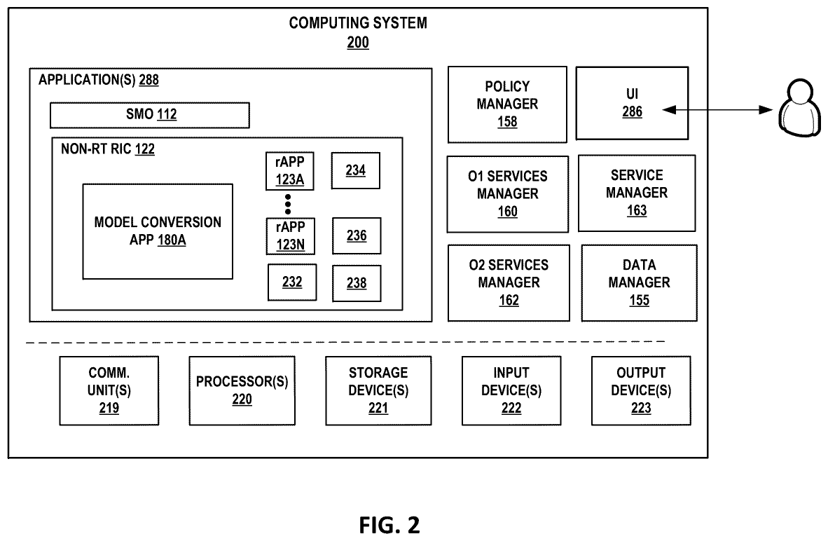

FIG. 2 is a block diagram illustrating example computing system 200 in detail, in accordance with techniques of this disclosure. In this example of FIG. 2, computing system 200 may implement, for example, an SMO 112 and/or a non-real time RIC, such as non-RT RIC 122 of FIGS. 1A-1C. While computing system 200 of FIG. 2 is depicted with respect to non-RT RIC 122 of FIGS. 1A-1C, a computing system, such as computing system 200, may also implement near-RT RIC 124 of FIGS. 1A-1C in a substantially similar fashion.

Computing system 200 includes processing circuitry 220, one or more input devices 222, one or more output devices 223, one or more communication units 219, and one or more storage device(s) 221. In some examples, computing system 200 is a cloud computing system, server farm, and/or server cluster (or portion thereof) that provides services to client devices and other devices or systems. In other examples, computing system 200 may be implemented through one or more virtualized compute instances (e.g., virtual machines, containers) of a data center, cloud computing system, server farm, and/or server cluster.

One or more of the devices, modules, storage areas, or other components of computing system 200 may be interconnected to enable inter-component communications (physically, communicatively, and/or operatively). In some examples, such connectivity may be provided by communication channels, a system bus (e.g., message bus 151 of FIG. 1B), a network connection, an inter-process communication data structure, or any other method for communicating data.

Processing circuitry 220 of computing system 200 may implement functionality and/or execute instructions associated with an SMO and/or a non-RT RIC or associated with one or more modules illustrated herein and/or described herein, including applications 288, policy manager 158, O1 services manager 160, O2 services manager 162, service manager 163, and data manager 155. Processing circuitry 220 may be, may be part of, and/or may include processing circuitry that performs operations in accordance with one or more aspects of the present disclosure. Examples of processing circuitry 220 include microprocessors, application processors, display controllers, auxiliary processors, one or more sensor hubs, and any other hardware configured to function as a processor, a processing unit, or a processing device. Computing system 200 may use processing circuitry 220 to perform operations in accordance with one or more aspects of the present disclosure using software, hardware, firmware, or a mixture of hardware, software, and firmware residing in and/or executing at computing system 200. Any one or more of applications 288, policy manager 158, O1 services manager 160, O2 services manager 162, service manager 163, and data manager 155 may be hosted by a cloud provider or other third-party.

One or more communication units 219 of computing system 200 may communicate with devices external to computing system 200 by transmitting and/or receiving data, and may operate, in some respects, as both an input device and an output device. In some examples, communication units 219 may communicate with other devices over a network. In other examples, communication units 219 may send and/or receive radio signals on a radio network such as a cellular radio network. In other examples, communication units 219 of computing system 200 may transmit and/or receive satellite signals on a satellite network such as a Global Positioning System (GPS) network. Examples of communication units 219 include a network interface card (e.g., an Ethernet card), an optical transceiver, a radio frequency transceiver, a GPS receiver, or any other type of device that can send and/or receive information. Other examples of communication units 219 may include devices capable of communicating over Bluetooth®, GPS, NFC, ZigBee, and cellular networks (e.g., 3G, 4G, 5G), and Wi-Fi® radios found in mobile devices as well as Universal Serial Bus (USB) controllers and the like. Such communications may adhere to, implement, or abide by appropriate protocols, including Transmission Control Protocol/Internet Protocol (TCP/IP), Ethernet, Bluetooth, NFC, or other technologies or protocols.

One or more input devices 222 may represent any input devices of computing system 200 not otherwise separately described herein. One or more input devices 222 may generate, receive, and/or process input from any type of device capable of detecting input from a human or machine. For example, one or more input devices 222 may generate, receive, and/or process input in the form of electrical, physical, audio, image, and/or visual input (e.g., peripheral device, keyboard, microphone, camera).

One or more output devices 223 may represent any output devices of computing system 200 not otherwise separately described herein. One or more output devices 223 may generate, receive, and/or process input from any type of device capable of detecting input from a human or machine. For example, one or more output devices 223 may generate, receive, and/or process output in the form of electrical and/or physical output (e.g., peripheral device, actuator). In some examples, output devices 223 provide UI 286 with which an administrator may interact with computing system 200.

One or more storage device(s) 221 within computing system 200 may store information for processing during operation of computing system 200. Storage device(s) 221 may store program instructions and/or data associated with one or more of the modules described in accordance with one or more aspects of this disclosure. Processing circuitry 220 and one or more storage device(s) 221 may provide an operating environment or platform for such modules, which may be implemented as software, but may in some examples include any combination of hardware, firmware, and software. Processing circuitry 220 may execute instructions and one or more storage device(s) 221 may store instructions and/or data of one or more modules. The combination of processing circuitry 220 and storage device(s) 221 may retrieve, store, and/or execute the instructions and/or data of one or more applications, modules, or software. Processing circuitry 220 and/or storage device(s) 221 may also be operably coupled to one or more other software and/or hardware components, including, but not limited to, one or more of the components of computing system 200 and/or one or more devices or systems illustrated as being connected to computing system 200.

In some examples, one or more storage device(s) 221 are temporary memories, meaning that a primary purpose of the one or more storage devices is not long-term storage. Storage device(s) 221 of computing system 200 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Storage device(s) 221, in some examples, also include one or more computer-readable storage media. Storage device(s) 221 may be configured to store larger amounts of information than volatile memory. Storage device(s) 221 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories.

Applications 288 may include SMO 112 and rApps 123A. SMO 112 provides orchestration, control management, and automation aspects of RAN 109 (e.g., network slicing, management, and orchestration of O-Cloud, etc.). Further, SMO 112 may control aspects of non-RT RIC 122 of FIGS. 1A-1C and near-RT RIC 124 of FIGS. 1A-1C.

As described above, rApps 123 may manage non-real time events within non-RT RIC 122, such as applications that do not require response times of less than one second. rApps 123 may leverage the functionality exposed via a non-RT RIC framework of computing device 200. rApps 123 may be used to control and manage RAN elements and resources, such as a near-RT RIC, RAN nodes, and/or resources in the O-RAN cloud. rApps 123 may provide one or more services that are performed using interfaces of computing system 200 (e.g., management interfaces such as the A1 interface, O1 interface, O2 interface, OAM interface etc.). Examples of rApps 123 may include, e.g., services such as policies 1 for a near-RT RIC, configuration instructions 234 for O-RAN managed elements, performance jobs 236 for O-RAN managed elements, services for managing the services and/or data 238, etc.

Computing system 200 may include one or more modules or units configured to perform one or more services or functions of applications 288, such as policy manager 158, O1 services manager 160, O2 services manager 162, service manager 163, and data manager 155, as described above.

For example, policy manager 158 is configured to control the deployment of policies (e.g., A1 services). For example, policy manager 158 may receive requests for A1 services from applications 123 (e.g., via R1 interface 154 of FIG. 1B), process the A1 services from applications 123, and perform the A1 services for a near-RT RIC using an A1 interface (e.g., A1 interface 164 of FIG. 1B). In some examples, the A1 interface may implement an A1 AP application protocol based on the 3GPP framework.

O1 services manager 160 is configured to control the deployment of O1 services for monitoring the performance of O-RAN managed elements (e.g., near-RT RIC 124, O-CU 146, O-DU 148 of FIG. 1B). For example, O1 services manager 160 may receive requests for O1 services for monitoring the performance of the near-RT RIC from applications 123 (e.g., via R1 interface 154 of FIG. 1B), process the O1 services, and perform the O1 services for the O-RAN managed elements using an O1 interface (e.g., O1 interface 166 of FIG. 1B). In some examples, the O1 interface may implement REST/HTTPS APIs and/or NETCONF.

O1 services manager 160 is additionally, or alternatively, configured to control the deployment of O1 services for the configuration of near-RT RIC 124 and/or RAN nodes. For example, O1 services manager 160 may receive requests for O1 services for the configuration of O-RAN managed elements from applications 123 (e.g., via R1 interface 154 of FIG. 1B), process the O1 services, and may perform the O1 services for the O-RAN managed elements using an O1 interface (e.g., O1 interface 166 of FIG. 1B).

O2 services manager 162 may be configured to control the deployment of O2 services for monitoring the performance of resources of the O-RAN cloud. For example, O2 services manager 162 may receive requests for O2 services for monitoring the performance of resources within the O-RAN cloud (e.g., via R1 interface 154 of FIG. 1B), process the O2 services, and may perform the O2 services for the resources of the O-RAN cloud using an O2 interface (e.g., O2 interface 167 of FIG. 1B).

O2 services manager 162 may additionally, or alternatively, be configured to control the deployment of O2 services for the configuration of resources of the O-RAN cloud. For example, O2 services manager 162 may receive requests for O2 services for configuring resources within the O-RAN cloud from applications 123 (e.g., via R1 interface 154 of FIG. 1B), process the O2 services, and may perform the O2 services for the resources of the O-RAN cloud using an O2 interface (e.g., O2 interface 167 of FIG. 1B).

Service manager 163 is configured to manage services, such as registration of a service, update of a service registration, service discovery, etc. For example, service manager 163 may receive requests for SME services from applications 123 (e.g., via R1 interface 154 of FIG. 1B), perform the SME service (e.g., register/update a service) for one or more applications 123, and send a response to the one or more applications 123 using an R1 interface (e.g., R1 interface 154 of FIG. 1B).

Data manager 155 is configured to manage the data of applications 123. For example, data manager 155 may receive requests for DME services from applications 123 (e.g., via R1 interface 154 of FIG. 1B), perform the DME services (e.g., sending data from application configured as a data producer to application configured as a data consumer) for one or more applications 123, and send a response to the one or more applications 123 using an R1 interface (e.g., R1 interface 154 of FIG. 1B).

In accordance with the techniques of the disclosure, model conversion application 180A may convert between data models within non-RT RIC 122 for mobile network 120. Using the techniques described herein, model conversion application 180A for non-RT RIC 122 provides capabilities for converting between the various different data models implemented across network system 100. In the example of FIG. 2, model conversion application 180A is an rApp executed by, e.g., non-RT RIC 122.

For example, model conversion application 180A receives, from non-RT RIC 122 via R1 interface 154, a first request specifying one or more first attributes according to a first data model. In some examples, the first request comprises a SME request for OAM data for RAN 109 formulated in accordance with a standardized data model. In some examples, non-RT RIC 122 sends the SME request for OAM data to model conversion application 180A in response to a determination that unique identifiers for RAN nodes specified by the SME request indicate one or more elements of RAN 109 that do not conform to the first data model. In some examples, the unique identifiers identify one or more EMSs 172 or one or more base stations 174. In some examples, the unique identifiers comprise one or more DNs corresponding to one or more EMSs 172 or one or more base stations 174. Model conversion application 180A generates, based at least in part on the one or more first attributes, a second request specifying one or more unique identifiers and one or more first objects according to a second data model. In some examples, the second request comprises a CM read request, a PM read request, or an FM read request formulated in accordance with a vendor-specific data model. In some examples, the second request is a request for OAM data from CUs and DUs of RAN 109. Model conversion application 180A sends, to non-RT RIC 122 via R1 interface 154, the second request for sending, by non-RT RIC 122, over OAM interface 171 to, e.g., one or more EMS(s) 172 and base station(s) 174 of RAN 109 for mobile network 120.

Non-RT RIC 122 receives, from one or more EMS(s) 172 and base station(s) 174 of RAN 109 for mobile network 120, a second response. The second response is responsive to the second request and specifies one or more second objects according to the second data model. In some examples, the second response comprises a CM read response responsive to the CM read request and formulated in accordance with the vendor-specific data model. In some examples, the second response comprises a PM read response responsive to the PM read request and formulated in accordance with the vendor-specific data model. In some examples, the second response comprises an FM read response responsive to the FM read request and formulated in accordance with the vendor-specific data model. Model conversion application 180A receives, from non-RT RIC 122, the second response over R1 interface 154. Model conversion application 180A generates, based at least in part on the one or more second objects, a first response, the first response specifying one or more second attributes according to the first data model and responsive to the first request. For example, the first response comprises an SME response responsive to the SME request formulated in accordance with the standardized data model. Model conversion application 180A provides, via R1 interface 154, the first response to non-RT RIC 122 to support OAM operations by non-RT RIC 122.

In some examples, model conversion application 180A may register a conversion service for the various different models (standards-specified or vendor-specific) supported by model conversion application 180A. Other applications (referred to as “operations applications” herein), may access the support service to take advantage of the model conversion capabilities of model conversion application 180A. In some examples, these “operations applications” may be any other rApp 123 of non-RT RIC 122 or xApps 125 of near-RT RIC 124 of FIG. 1C. For example, rApps 123 or xApps 125 may be one or more OAM management entities that consume OAM data of devices of RAN 109 so as to provide management of one or more MFs or MEs. As described herein, model conversion application 180A receives, from the operations application via R1 interface 154, first information according to a first data model, such as an SME request for OAM information formulated according to a standards-based, O-RAN data model. Model conversion application 180A generates, based at least in part on the first information, second information according to a second data model. For example, model conversion application 180A generates a CM read request for OAM information formulated according to a vendor-specific data model. In other examples, model conversion application 180A generates a PM read request or an FM read request formulated according to a vendor-specific data model. Model conversion application 180A sends, to the operations application via R1 interface 154, the second information.

For example, model conversion application 180A receives, from non-RT RIC 122 via R1 interface 154, data specifying a device inventory for RAN 109. The device inventory comprises a list of devices within RAN 109 and make, model, and version information for the devices. Model conversion application 180A determines that at least one device specified by the device inventory corresponds to a data model supported by model conversion application 180A. Model conversion application 180A sends a SME request to non-RT RIC 122, the SME request configured to register a support service for the at least one device.

Subsequently, non-RT RIC 122 receives, via R1 interface 154 from an operations application such as rApp 123A, a request for information specifying available services of non-RT RIC 122. Non-RT RIC 122 sends, via R1 interface 154 and to rApp 123A, information specifying available services. The information specifying available services indicates an availability of one or more support services for one or more devices of RAN 109.

With respect to the foregoing example, rApp 123A is an OAM management entity for one or more EMS(s) 172 and base station(s) 174 of RAN 109 and receives information specifying a support service for one or more EMS(s) 172 and base station(s) 174 of RAN 109. In this example, model conversion application 180A receives, from rApp 123A via R1 interface 154, an SME request for OAM information formulated according to a standards-based, O-RAN data model. Model conversion application 180A generates a CM read request for OAM information formulated according to a vendor-specific data model used by one or more EMS(s) 172 and base station(s) 174 of RAN 109. In other examples, model conversion application 180A generates a PM read request or an FM read request formulated according to a vendor-specific data model used by one or more EMS(s) 172 and base station(s) 174 of RAN 109. Model conversion application 180A sends, to rApp 123A via R1 interface 154, the second information. rApp 123A may send, via R1 interface 154, the CM read request for OAM information to non-RT RIC 122 for sending, via OAM interface 171, to one or more EMS(s) 172 and base station(s) 174 of RAN 109. Non-RT RIC 122, rApp 123A, and model conversion application 180A may operate in a substantially similar fashion to convert responses from one or more EMS(s) 172 and base station(s) 174 of RAN 109 including OAM information formulated according to the vendor-specific data model into responses including OAM information formulated according to the standards-based, O-RAN data model. In this fashion, model conversion application 180A operates to convert OAM information formulated according to a first data model into OAM information formulated according to a second data model, thereby facilitating the use by non-RT RIC 122 and rApp 123A of standards-based OAM data models while maintaining support of devices of RAN 109 that may use various vendor-specific OAM data models.

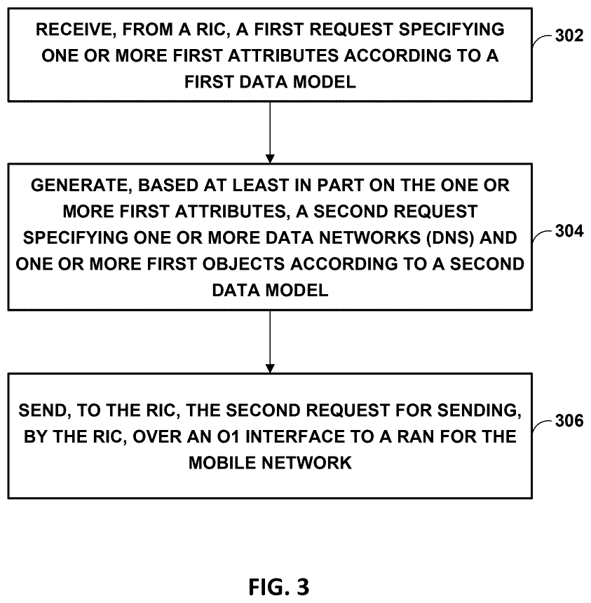

FIG. 3 is a flowchart illustrating an example operation in accordance with the techniques of this disclosure. FIG. 3 is described with respect to computing system 200 of FIG. 2 for convenience. However, the operation of FIG. 3 may also be performed by non-RT RIC 122 or near-RT RIC 124 of FIGS. 1A-1C.

As depicted in the example of FIG. 3, model conversion application 180A converts between data models within non-RT RIC 122 for mobile network 120. Using the techniques described herein, model conversion application 180A for non-RT RIC 122 provides capabilities for converting between the various different data models implemented across network system 100.

For example, model conversion application 180A receives, from non-RT RIC 122 via R1 interface 154, a first request specifying one or more first attributes according to a first data model (302). In some examples, the first request comprises a SME request for OAM data for RAN 109 formulated in accordance with a standardized data model. Model conversion application 180A generates, based at least in part on the one or more first attributes, a second request specifying one or more unique identifiers and one or more first objects according to a second data model (304). In some examples, the unique identifiers identify one or more EMSs 172 or one or more base stations 174. In some examples, the unique identifiers comprise one or more DNs corresponding to one or more EMSs 172 or one or more base stations 174. In some examples, the second request comprises a CM read request, a PM read request, or an FM read request formulated in accordance with a vendor-specific data model. In some examples, the second request is a request for OAM data from CUs and DUs of RAN 109. Model conversion application 180A sends, to non-RT RIC 122 via R1 interface 154, the second request for sending, by non-RT RIC 122, over OAM interface 171 to, e.g., one or more EMS(s) 172 and base station(s) 174 of RAN 109 for mobile network 120 (306).

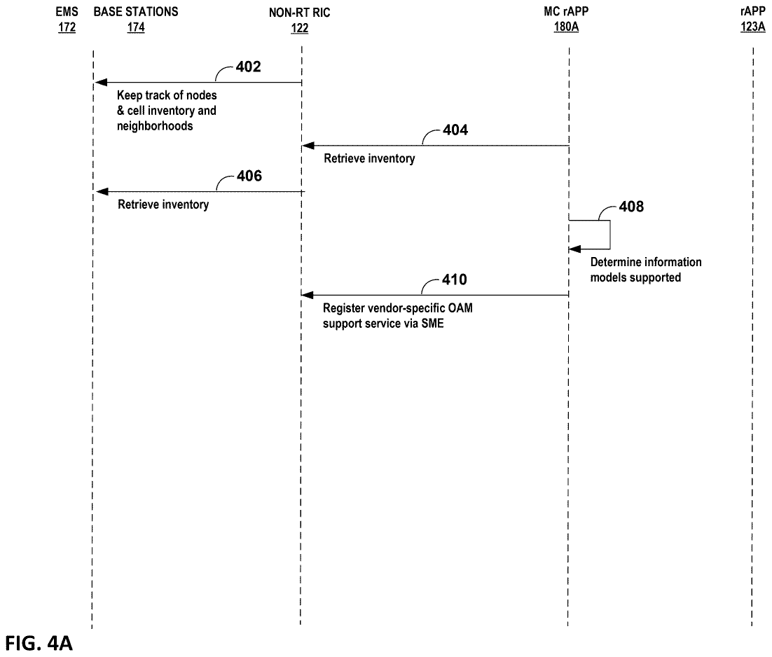

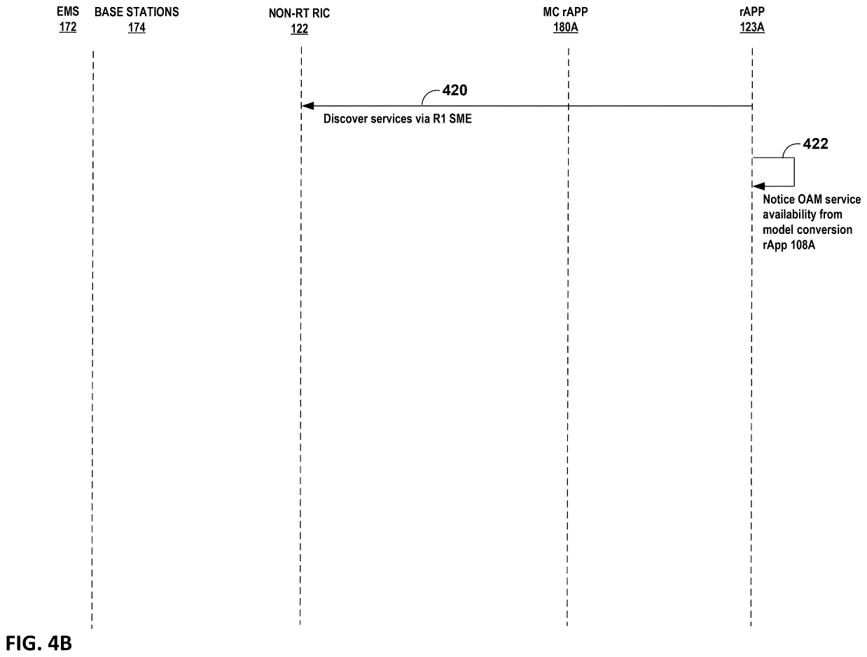

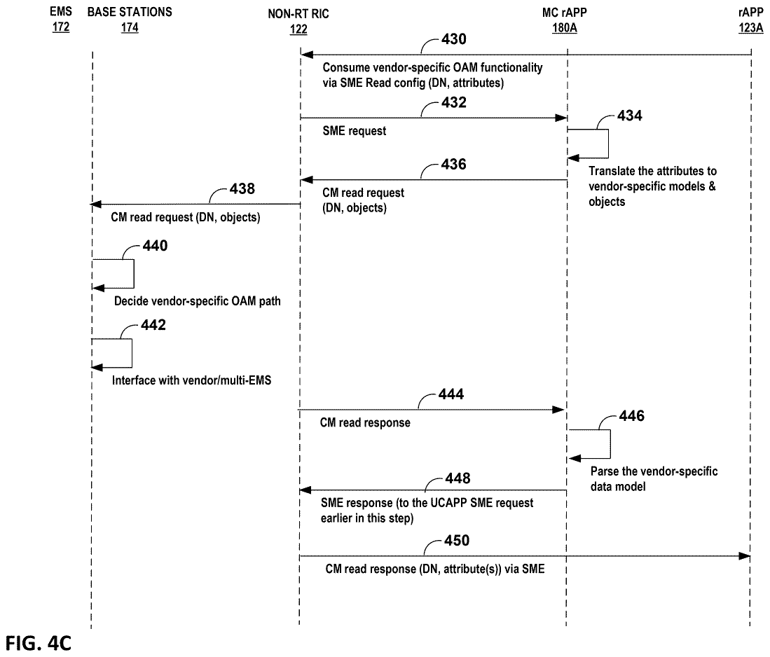

FIGS. 4A-4C are flowcharts illustrating example operations in accordance with the techniques of this disclosure. FIGS. 4A-4C are described with respect to network system 100 of FIG. 2 for convenience. The example of FIGS. 4A-4C are provided with respect to the handling of a CM read request. However, in other examples, non-RT RIC 122, model conversion rApp 180A, rApp 123A may perform in a substantially similar fashion to handle PM read requests and responses and/or FM read requests and responses. In addition, the example of FIGS. 4A-4C are described with respect to non-RT RIC 122 and rApps, but the operations of FIGS. 4A-4C may also be performed by near-RT RIC 124 and xApps in a substantially similar fashion.

FIG. 4A is a flowchart illustrating an example operation wherein model conversion application 180A retrieves and determines information models supported. As depicted in FIG. 4A, non-RT RIC 122 requests, from one or more EMS(s) 172 and base station(s) 174 of RAN 109, information so as to keep track of node and cell inventory and neighborhoods (402). Model conversion application 180A retrieves the inventory from non-RT RIC 122 (404), and in response, non-RT RIC 122 retrieves the inventory from one or more EMS(s) 172 and base station(s) 174 of RAN 109 (406). Model conversion application 180A determines the information models supported (408). Model conversion application 180A registers, with non-RT RIC 122, a vendor-specific OAM support service via SME (410).

FIG. 4B is a flowchart illustrating an example operation wherein an operations application, such as rApp 123A, discovers services available on non-RT RIC 122. For example, rApp 123A issues a request to non-RT RIC 122 via an R1 SME to discover services available on non-RT RIC 122 (420). rApp 123A determines an availability of an OAM service from model conversion application 180A (422).

FIG. 4C is a flowchart illustrating an example operation wherein model conversion application 180A assists with OAM service consumption. For example, rApp 123A consumes, from non-RT RIC 122, vendor-specific OAM functionality via SME Read config (DN, attribute(s)) (430). In some examples, non-RT RIC 122 determines, based on the DN attributes from the SME read configuration, that the RAN nodes corresponding to the DN attributes do not implement O-RAN. In response to the determination that the RAN nodes do not implement O-RAN, Non-RT RIC 122 sends, to model conversion application 180A, the SME request (432). Model conversion application 180A translates the attributes to vendor-specific data models and/or objects (434). Model conversion application 180A sends, to non-RT RIC 122, a CM read request (DN, objects) (436). Non-RT RIC 122 sends, to one or more EMS(s) 172 and base station(s) 174 of RAN 109 (438) the CM read request (DN, objects) (438). one or more EMS(s) 172 and base station(s) 174 of RAN 109 determine a vendor-specific OAM path (440) and interface with vendor-or multi-EMS services (442). Non-RT RIC 122 sends, to model conversion application 180A, a CM read response obtained from one or more EMS(s) 172 and base station(s) 174 of RAN 109 (444). Model conversion application 180A parses the vendor-specific data model (446) and sends, to non-RT RIC 122, an SME response (to the earlier SME request 432 from rApp 123A) (448). Non-RT RIC 122 sends, to rApp 123A, the CM read response (DN, attribute(s)) via SME (450).

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A computing system comprising processing circuitry having access to a memory, the processing circuitry configured to:
execute a model conversion application for a Radio Access Network (RAN) Intelligent Controller (RIC) for a mobile network, the model conversion application configured to:
receive, from the RIC, a first request specifying one or more first attributes according to a first data model;
generate, based at least in part on the one or more first attributes, a second request specifying one or more unique identifiers for nodes of the RAN and one or more first objects according to a second data model; and
send, to the RIC, the second request for sending, by the RIC, over a management interface to a RAN for the mobile network.

2. The computing system of claim 1,
wherein the one or more unique identifiers comprise one or more distinguished names (DNs) for the nodes of the RAN,
wherein the first request according to the first data model comprises a Service Management and Exposure (SME) request,
wherein the second request according to the second data model comprises at least one of a Configuration Management (CM) read request, a Performance Management (PM) read request, or a Fault Management (FM) read request, that specifies the one or more DNs and the one or more first objects.

3. The computing system of claim 1, wherein the model conversion application is further configured to:
receive, from the RIC, a second response received by the RIC over the management interface, the second response responsive to the second request and specifying one or more second objects according to the second data model;
generate, based at least in part on the one or more second objects, a first response, the first response specifying one or more second attributes according to the first data model and responsive to the first request; and
send, to the RIC, the first response.

4. The computing system of claim 3,
wherein the one or more unique identifiers comprise one or more distinguished names (DNs) for the nodes of the RAN,
wherein the first request according to the first data model comprises a Service Management and Exposure (SME) request,
wherein the second request according to the second data model comprises at least one of a Configuration Management (CM) read request, a Performance Management (PM) read request, or a Fault Management (FM) read request, that specifies the one or more DNs and the one or more first objects,
wherein the second response according to the second data model comprises at least one of a CM read response responsive to the CM read request, a PM read response responsive to the PM read request, or an FM read response responsive to the FM read request, the second response specifying the one or more second objects according to the second data model, and
wherein the first response according to the first data model comprises an SME response responsive to the SME request and specifying the one or more second attributes according to the first data model.

5. The computing system of claim 1, wherein the second request comprises a request for Operations, Administration, and Maintenance (OAM) data for one or more network devices of the RAN.

6. The computing system of claim 1, wherein the model conversion application is further configured to:
receive, from the RIC, data specifying a device inventory for the RAN;
determine that at least one device specified by the device inventory corresponds to a data model supported by the model conversion application; and
send a Service Management and Exposure (SME) request to the RIC configured to register a support service for the at least one device.

7. The computing system of claim 6, further comprising the RIC executed by the processing circuitry, wherein the RIC is configured to:
receive, from an operations application and via an R1 interface, a request for information specifying available services; and
send, to the operations application and via the R1 interface, the information specifying available services, the information specifying available services indicating an availability of the support service for the at least one device.

8. The computing system of claim 1, wherein the model conversion application is further configured to:
receive, from an operations application executed by the processing circuitry via an R1 interface, first information according to the first data model;
generate, based at least in part on the first information, second information according to the second data model; and
send, to the operations application via an R1 interface, the second information.

9. The computing system of claim 1,
wherein the model conversion application is configured to receive the first request from the RIC via an R1 interface, and
wherein the model conversion application is configured to send the second request to the RIC via the R1 interface.

10. The computing system of claim 1, wherein the RIC comprises a near-real-time RIC of an Open Radio Access Network (O-RAN) architecture, and wherein the model conversion application comprises an xApp of the near-real-time RIC.

11. The computing system of claim 1, wherein the RIC comprises a non-real-time RIC of an Open Radio Access Network (O-RAN) architecture, and wherein the model conversion application comprises an rApp of the non-real-time RIC.

12. The computing system of claim 1, wherein the mobile network comprises at least one of a 4th generation (4G) mobile network, a 5th generation (5G) mobile network, or a 6th generation (6G) mobile network.

13. A method comprising:
receiving, by a model conversion application for a Radio Access Network (RAN) Intelligent Controller (RIC) for a mobile network, from the RIC, a first request specifying one or more first attributes according to a first data model, the model conversion application executed by processing circuitry;
generating, by the model conversion application and based at least in part on the one or more first attributes, a second request specifying one or more unique identifiers for nodes of the RAN and one or more first objects according to a second data model; and
sending, by the model conversion application and to the RIC, the second request for sending, by the RIC, over a management interface to a RAN for the mobile network.

14. The method of claim 13, further comprising:
receiving, by the model conversion application and from the RIC, a second response received by the RIC over the management interface, the second response responsive to the second request and specifying one or more second objects according to the second data model;
generating, by the model conversion application and based at least in part on the one or more second objects, a first response, the first response specifying one or more second attributes according to the first data model and responsive to the first request; and
sending, by the model conversion application and to the RIC, the first response.

15. The method of claim 14,
wherein the one or more unique identifiers comprise one or more distinguished names (DNs) for the nodes of the RAN,
wherein the first request according to the first data model comprises a Service Management and Exposure (SME) request,
wherein the second request according to the second data model comprises at least one of a Configuration Management (CM) read request, a Performance Management (PM) read request, or a Fault Management (FM) read request, that specifies the one or more DNs and the one or more first objects,
wherein the second response according to the second data model comprises at least one of a CM read response responsive to the CM read request, a PM read response responsive to the PM read request, or an FM read response responsive to the FM read request, the second response specifying the one or more second objects according to the second data model, and
wherein the first response according to the first data model comprises an SME response responsive to the SME request and specifying the one or more second attributes according to the first data model.

16. The method of claim 13, wherein the second request comprises a request for Operations, Administration, and Maintenance (OAM) data for one or more network devices of the RAN.

17. The method of claim 13, further comprising:
receiving, by the model conversion application and from the RIC, data specifying a device inventory for the RAN;
determining, by the model conversion application, that at least one device specified by the device inventory corresponds to a data model supported by the model conversion application; and
sending, by the model conversion application, a Service Management and Exposure (SME) request to the RIC configured to register a support service for the at least one device.

18. The method of claim 13, further comprising:
receiving, by the model conversion application and from an operations application executed by the processing circuitry via an R1 interface, first information according to the first data model;
generating, by the model conversion application and based at least in part on the first information, second information according to the second data model; and
sending, by the model conversion application and to the operations application via an R1 interface, the second information.

19. The method of claim 13,
wherein the model conversion application is configured to receive the first request from the RIC via an R1 interface, and
wherein the model conversion application is configured to send the second request to the RIC via the R1 interface.

20. Non-transitory, computer-readable media comprising instructions that, when executed, are configured to cause processing circuitry to:
execute a model conversion application for a Radio Access Network (RAN) Intelligent Controller (RIC) for a mobile network, the model conversion application configured to:
receive, from the RIC, a first request specifying one or more first attributes according to a first data model;
generate, based at least in part on the one or more first attributes, a second request specifying one or more unique identifiers for nodes of the RAN and one or more first objects according to a second data model; and
send, to the RIC, the second request for sending, by the RIC, over a management interface to a RAN for the mobile network.
